(19) United States
(12) Patent Application Publication
(10) Pub. No.: US 2026/0361390 A1
(43) Pub. Date: Nov. 12, 2026

(54) DETERMINING TRANSMISSION CONFIGURATION INDICATOR (TCI) STATE LISTS FOR MULTIPLE TRANSMISSION RECEPTION POINTS (MTRP)

(71) Applicant: Google LLC, Mountain View, CA (US)

(72) Inventors: Yushu Zhang, Beijing (CN); Jia-Hong Liou, Taipei (TW); Chih-Hsiang Wu, Taipei (TW)

(21) Appl. No.: 19/120,185

(22) PCT Filed: Oct. 10, 2022
(86) PCT No.: PCT/CN2022/124409

§ 371 Date: Apr. 10, 2025

(51) Int. Cl. H04B 7/06; H04W 72/231; H04W 76/20; H04W 80/02

(52) U.S. Cl. CPC H04B 7/06968; H04W 72/231; H04W 76/20; H04W 80/02

(57) ABSTRACT

A UE (102) receives (305), from a network entity (106a), a configuration for a TCI state list for a first serving cell that corresponds to a reference cell. The UE (102) further receives (309), from the network entity (106a), a first parameter and a second parameter that define an other TCI state list for a second serving cell. The first parameter indicates a type of the other TCI state list for the second serving cell and the second parameter indicates at least one of: a serving cell index for the first serving cell or one or more TCI state IDs in the TCI state list. The UE (102) communicates (377) with the network entity (106a) using the other TCI state list for the second serving cell. The other TCI state list is based on the second parameter and the TCI state list for the first serving cell.

### TECHNICAL FIELD

The present disclosure relates generally to wireless communication, and more particularly, to transmission configuration indicator (TCI) state lists for multiple transmission reception points (mTRPs).

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband have been useful to continue the progression of such wireless communication technologies. For example, a unified transmission configuration indicator (TCI) framework has been implemented for downlink and uplink communications between a base station and a user equipment (UE) in single transmission reception point (TRP) use cases. However, determining TCI state lists in multiple TRP (mTRP) uses cases might be associated with additional complexities.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later, A network entity, such as a base station or a unit of a base station, may communicate with a user equipment (UE) on downlink or uplink using a unified transmission configuration indicator (TCI) framework. However, implementations of the unified TCI framework might be limited to single transmission reception point (TRP) use cases, and not extended to multiple TRP (mTRP) uses cases. That is, from a perspective of the UE, channel transmissions, reference signals, etc., might be transmitted toward or received from the single TRP, such that the UE might determine a single TCI state associated with the single TRP.

A TCI state list for a second serving cell can either be explicitly indicated by a network entity, such as in a radio resource control (RRC) configuration message, or determined based on reference to a different, first serving cell. An explicit indication of the TCI state list for the second serving cell might correspond to a dl-orJoint-TCI-State-List parameter and/or an ul-TCI-State-List parameter indicated via the RRC configuration message. A reference-based determination of the TCI state list might involve receiving a parameter that indicates a cell identifier (ID) of the first serving cell. This parameter means that the second serving cell of the UE can (re)use the same TCI state list as the indicated first serving cell. However, referring to the different, first serving cell to obtain a TCI state list for the second serving cell of the UE might create incompatibilities when the TCI framework of the first serving cell is associated with a single TRP while the second cell is associated with mTRPs.

Aspects of the present disclosure address the above-noted and other deficiencies by implementing referencing procedures for the TCI state list in examples associated with the mTRPs. For instance, the TCI state list for a single TRP serving cell may be referenced by an mTRP serving cell, and the TCI state list for the mTRP serving cell may be referenced by the single TRP serving cell. The TCI state list(s) can be determined at the UE and/or at the network entity for single TRP and/or mTRP use cases.

According to some aspects, the UE receives, from the network entity, a configuration for a TCI state list for a first serving cell, where the first serving cell corresponds to a reference cell. The UE further receives, from the network entity, a first parameter and a second parameter that define an other TCI state list for a different, second serving cell. The first parameter indicates a TCI state list type (e.g., joint/separate) of the second serving cell. The second parameter indicates at least one of: (i) a serving cell index for the first serving cell or (ii) one or more TCI state IDs in the TCI state list. The UE communicates with the network entity using the other TCI state list for the second serving cell, where the other TCI state list is based on the second parameter and the TCI state list for the first serving cell.

According to some aspects, the network entity transmits, to the UE, the configuration and parameters described above. The network entity communicates with the UE using the other TCI state list for the second serving cell as described above.

According to some aspects, a second network entity transmits, to a first network entity, the configuration for the TCI state list for the first serving cell, where the first serving cell corresponds to the reference cell. The second network entity further transmits, to the first network entity, the first parameter and the second parameter for the other TCI state list for the second serving cell. The second network entity communicates with the UE using the other TCI state list for the second serving cell.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates a signaling diagram for a UE, a base station, and multiple transmission reception points (mTRPs).

FIG. 3 illustrates a signaling diagram for determining one or more transmission configuration indicator (TCI) state lists associated with mTRPs.

FIG. 4 illustrates a signaling diagram for determining one or more TCI state lists based on multiple reference cells.

FIG. 5 is a flowchart of a method of wireless communication at a UE.

FIG. 6 is a flowchart of a method of wireless communication at a first network entity.

FIG. 7 is a flowchart of a method of wireless communication at a second network entity.

FIG. 8 is a diagram illustrating an example of a hardware implementation for an example UE apparatus.

FIG. 9 is a diagram illustrating an example of a hardware implementation for one or more example network entities.

### DETAILED DESCRIPTION

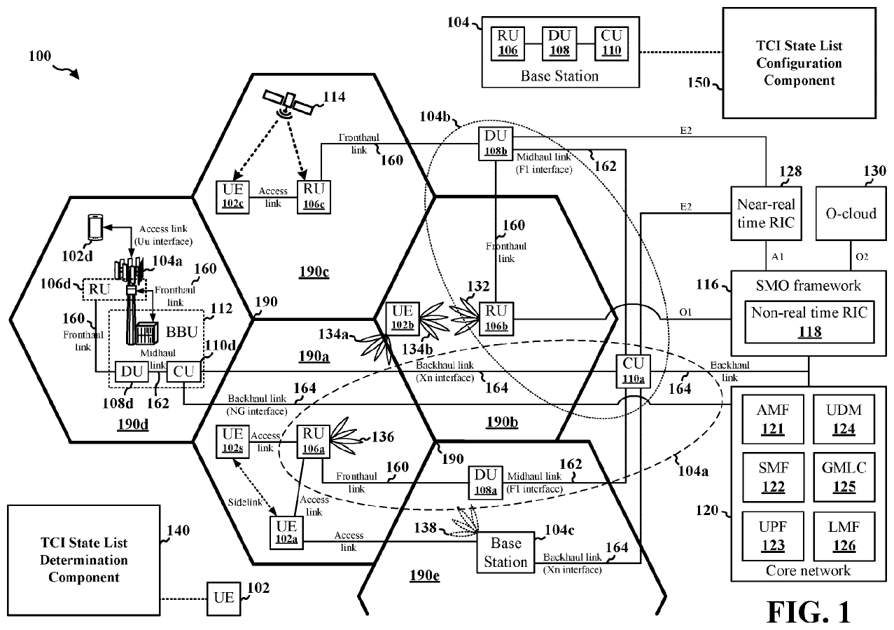

FIG. 1 illustrates a diagram 100 of a wireless communications system associated with a plurality of cells 190. The wireless communications system includes user equipments (UEs) 102 and base stations 104, where some base stations 104c include an aggregated base station architecture and other base stations 104a-104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TRP).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an Al link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUS 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUS 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the 02 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the Al interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the Al link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FRI is actually greater than 6 GHZ, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHZ, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190c may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a TCI state list determination component 140 configured to receive, from a network entity, a configuration for a transmission configuration indicator (TCI) state list for a first serving cell, the first serving cell corresponding to a reference cell; receive, from the network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state identifiers (IDs) in the TCI state list; and communicate with the network entity using the other TCI state list for the second serving cell, the other TCI state list based on the second parameter and the TCI state list for the first serving cell.

In certain aspects, the base station 104 or a network entity of the base station 104 may include a TCI state list configuration component 150 configured to transmit, to a UE, a configuration for a TCI state list for a first serving cell, the first serving cell corresponding to a reference cell; transmit, to the UE, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and communicate with the UE using the other TCI state list for the second serving cell, the other TCI state list based on the second parameter and the TCI state list for the first serving cell. The TCI state list configuration component 150 is further configured to transmit, to a first network entity, a configuration for a TCI state list for a first serving cell, the first serving cell corresponding to a reference cell; transmit, to the first network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state identifiers (IDs) in the TCI state list; and communicate with a UE using the other TCI state list for the second serving cell, the other TCI state list based on the second parameter and the TCI state list for the first serving cell.

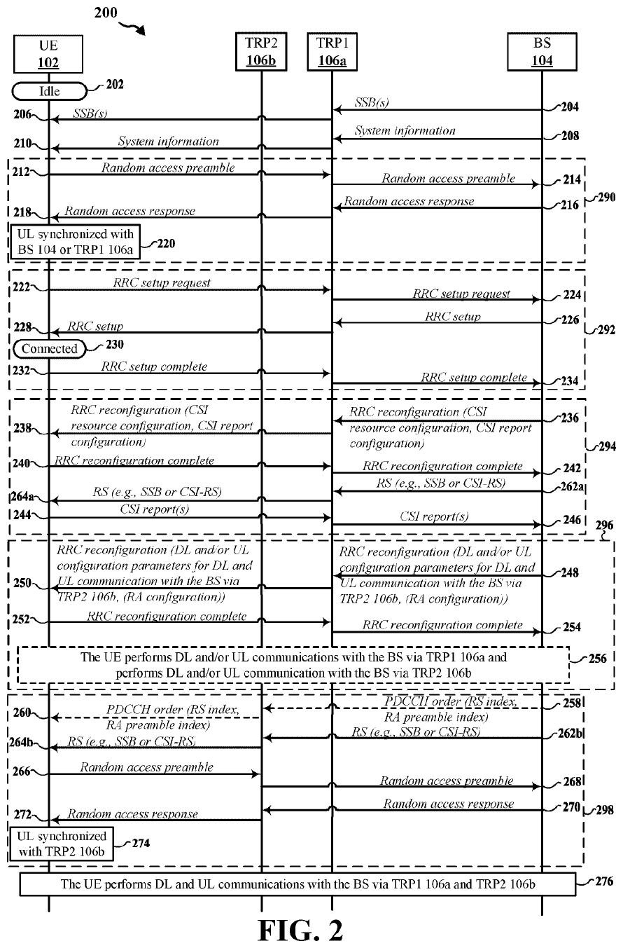

Accordingly, FIG. 1 describes a wireless communication system that may be implemented in connection with aspects of one or more other figures described herein, such as aspects illustrated in FIGS. 2-4. Further, although the following description may be focused on 5G NR, the concepts described herein may be applicable to other similar areas, such as 5G-Advanced and future versions, LTE, LTE-advanced (LTE-A), and other wireless technologies.

FIG. 2 illustrates a signaling diagram 200 for a UE 102, a base station 104 that operates the cell 190a, a TRP1 106a, and a TRP2 106b. According to the signaling diagram 200, the base station 104 broadcasts 204, 206 (e.g., periodically) one or more synchronization signal blocks (SSB(s)) and broadcasts 208, 210 system information via the TRP1 106a. The system information can include a master information block (MIB) and/or system information block(s) (SIB(s)). For example, the SIB(s) include a SIBI and can further include SIB2, SIB3, SIB4, and/or SIB5. The UE 102 initially operates 202 in an idle state (e.g., RRC_IDLE state). The UE 102 in the idle state receives 206 the SSB(s) and receives 210 the system information from the base station 104 via the TRP1 106a. In some implementations, the UE 102 detects that the base station 104 transmits 204 the SSB(s) via the TRPI 106a. In some implementations, the UE 102 then uses one of the SSB(s) to perform downlink synchronization on the cell 190a with the base station 104 via the TRPI 106a, and receives 210 the system information via the TRPI 106a based on the SSB.

The UE 102 might perform a random access procedure 290 to initiate an RRC connection establishment procedure 292. Thus, the UE 102 can transmit 212 a first random access preamble on a time/frequency resource and/or a random access channel (RACH) occasion to the TRP1 106a, and the TRP1 106a can forward 214 the first random access preamble to the base station 104. In some implementations, the UE 102 selects an SSB, from the SSB(s) for which an RSRP obtained by the UE 102 is above a first threshold (e.g., rsrp-ThresholdSSB), for the random access procedure, In other implementations, in cases where none of the SSB(s) are above the first threshold, the UE 102 selects an SSB from the SSB(s) and uses the SSB to determine the first random access preamble. In such cases, the UE 102 can select the SSB from the SSB(s) randomly or select based on a specific UE-implementation, The UE 102 then determines the first random access preamble, time/frequency resource and/or RACH occasion, based on the selected SSB and random access configuration parameters included in the system information (e.g., the SIBI). In some implementations, the random access configuration parameters indicate one or more associations between SSB(s) and random access preamble(s), RACH occasion(s), and/or time/frequency resource(s). Based on the selected SSB and the association(s), the UE 102 determines the first random access preamble, the RACH occasion, and/or time/frequency resource to transmit the first random access preamble.

In response to receiving 214 the first random access preamble, the base station 104 transmits 216 a first random access response to the TRP1 106a and the TRPI 106a then forwards 218 the first random access response to the UE 102. In some implementations, the base station 104 or the TRPI 106a can identify an SSB associated with the first random access preamble, RACH occasion, and/or time/frequency resource. In cases where a single SSB is associated with the first random access preamble, RACH occasion, and/or time/frequency resource, the identified SSB can be the SSB selected by the UE 102. In cases where multiple SSBs are associated with the first random access preamble, RACH occasion, and/or time/frequency resource, the identified SSB may be the same as or different from the SSB selected by the UE 102. In such implementations, the base station 104 transmits 216 the first random access response to the UE 102 via the TRP1 106a, based on the identified SSB. The base station 104 includes a first preamble ID and a first timing advance (TA) command in the first random access response. The first preamble ID identifies the first random access preamble. The first TA command includes a first TA value.

In some cases, the UE 102 applies the first TA value, and the UE 102 determines or maintains 220 an uplink that is synchronized (e.g., time aligned) with the BS 104 (or the TRP1 106a and/or the TRP2 106b) after (e.g., in response to) applying the first TA value. In some cases, the UE 102 supports multiple-TA-value operation in a serving cell. In such cases, the UE 102 applies the first TA value and determines or maintains 220 an uplink that is synchronized (e.g., time aligned) with the TRPI 106a after (e.g., in response to) applying the first TA value. The UE 102 applies the first TA value for transmitting (subsequent) UL transmissions (e.g., physical uplink control channel (PUCCH) transmissions, physical uplink shared channel (PUSCH) transmissions, and/or sounding reference signal transmissions) until a new or different TA value is received from the base station 104 that updates the first TA value. In some implementations, the UE 102 starts a first time alignment timer (TAT) to maintain 220 (first) UL synchronization (status) with the TRPI 106a or the base station 104 after or upon receiving the first TA command. In some implementations, the base station 104 includes an UL grant (i.e., a RAR grant) in the random access response.

In some implementations, the base station 104 starts a parallel first TAT to maintain a first UL synchronization for UL and/or DL communication with the UE 102 via the TRP1 106a, after (e.g., in response to) transmitting 216 the random access response or the first TA command to the UE 102. In some implementations, the TRPI 106a generates timing information for, or based on, the first random access preamble received 212 from the UE 102 and transmits 214 the timing information to the base station 104. For example, the timing information can indicate a propagation delay or a propagation delay shift. Based on the timing information received 214 from the TRP1 106a, the base station 104 determines the first TA value.

Elements 212, 214, 216, 218, and 220 are collectively referred to in FIG. 2 as the random access procedure 290.

After (or during) the random access procedure 290, the UE 102 transmits 222, 224 an RRC setup request message (e.g., RRCSetupRequest message) to the base station 104 via the TRP1 106a. In some implementations, the UE 102 transmits 222 the RRC setup request message using the UL grant received 218 in the random access response. In response to the RRC setup request message, the base station 104 transmits 226, 228 an RRC setup message (e.g., RRCSetup message) to the UE 102 via the TRP1 106a. In some implementations, the base station 104 can transmit a MAC protocol data unit (PDU) including a contention resolution identity (e.g., in a MAC-control element (MAC-CE)) to the UE 102 to resolve a contention for the random access procedure 290. In some implementations, the base station 104 includes the RRC setup message in the MAC PDU. In other implementations, after transmitting the MAC PDU, the base station 104 transmits another MAC PDU including the RRC setup message to the UE 102. In response to receiving 228 the RRC setup message, the UE 102 transitions 230 to a connected state (e.g., RRC_CONNECTED) and transmits 232, 234 an RRC setup complete message (e.g., RRCSetupComplete message) to the base station 104 via the TRPI 106a.

After performing the RRC connection establishment procedure 292 with the UE 102, the base station 104 can perform (not shown) a security activation procedure with the UE 102 to activate security protection (e.g., integrity protection/integrity check and encryption/decryption) for UL data and DL data communicated 256, 276 between the UE 102 and base station 104. After performing the RRC connection establishment procedure 292 or security activation procedure, the base station 104 can perform (also not shown) a radio bearer configuration procedure with the UE 102 to configure a signaling radio bearer-2 (SRB2) and/or a data radio bearer (DRB) for the UE 102.

After performing the RRC connection establishment procedure 292, security activation procedure, or radio bearer configuration procedure, the base station 104 transmits 236, 238, to the UE 102 via the TRPI 106a, an RRC reconfiguration message (e.g., RRCReconfiguration message) including a channel state information (CSI) resource configuration and a CSI reporting configuration. In response, the UE 102 transmits 240, 242 an RRC reconfiguration complete message (e.g., RRCReconfigurationComplete message) to the base station 104 via the TRP1 106a. In some implementations, the CSI resource configuration includes configuration parameters configuring channel state information-reference signal(s) (CSI-RS(s)) from multiple TRPs 106a, 106b for the UE 102 to measure.

The base station 104 can transmit 262a, 264a, 262b, 264b a reference signal (e.g., SSB or CSI-RS) to the UE 102 via the TRP1 106a or the TRP2 106b. For example, the base station 104 transmits 262b, 264b the CSI-RS(s) via the TRP2 106b in accordance with the CSI resource configuration. The UE 102 performs measurements on the CSI-RS(s) in accordance with the CSI resource configuration. In some implementations, the CSI resource configuration includes configuration parameters configuring SSB(s) for the UE 102 to measure. The base station 104 transmits 262b, 264b the SSB(s) via the TRP2 106b. The UE 102 performs measurements on the SSB(s) in accordance with the CSI resource configuration. In other implementations, the RRC reconfiguration message or CSI resource configuration does not include configuration parameters configuring SSB(s). In such cases, the base station 104 may still transmit SSB(s) via the TRP2 106b, and the UE 102 may perform measurements on the SSB(s).

The base station 104 can transmit 262a, 264a a reference signal (e.g., SSB or CSI-RS) to the UE 102 via the TRPI 106a. Based on the CSI reporting configuration, the UE 102 generates CSI report(s) from the measurements of the CSI-RS(s) or the SSB(s) and transmits 244, 246 the CSI report(s) to the base station 104 via the TRPI 106a. In some implementations, the UE 102 transmits 244, 246 the CSI report(s) on a PUCCH to the base station 104 via the TRP1 106a. In some implementations, the CSI reporting configuration configures a periodic or semi-persistent reporting, or configures a semi-persistent or aperiodic reporting triggered by downlink control information (DCI). The CSI report(s) include periodic CSI report(s), semi-persistent CSI report(s) and/or aperiodic CSI report(s).

In some implementations, the base station 104 includes the CSI resource configuration and/or the CSI report configuration in a CSI measurement configuration (e.g., CSI-MeasConfig information element (IE)). The base station 104 then includes the CSI measurement configuration in the RRC reconfiguration message transmitted 236, 238 to the UE 102 via the TRPI 106a. In other implementations, the CSI resource configuration includes NZP-CSI-RS-Resource IE(s), NZP-CSI-RS-ResourceSet IE(s), CSI-SSB-ResourceSet IE(s), CSI-ResourceConfig IE(s), and/or CSI-ReportConfig IE(s).

Elements 236, 238, 240, 242, 244, 246, 262a, and 264a are collectively referred to in FIG. 2 as a CSI resource configuration and/or a CSI reporting procedure 294.

After receiving 244, 246 the CSI report(s) via the TRP1 106a, the base station 104 determines to communicate 256, 276 with the UE 102 via the TRP2 106b based on the CSI report(s) while maintaining the (radio) link with the UE 102 via the TRPI 106a. In some implementations, the base station 104 makes the determination based on one or more capabilities of the UE 102. In response to the determination, the base station 104 transmits 248, 250, to the UE 102 via the TRPI 106a, an RRC reconfiguration message that includes DL and/or UL configuration parameters for DL and/or UL communication respectively with the base station 104 via TRP2 106b. In some implementations, the base station 104 includes the DL and UL configuration parameters in a CellGroupConfig IE and includes the CellGroupConfig IE in the RRC reconfiguration message. In some implementations, the base station 104 includes the DL configuration parameters in a BWP-DownlinkDedicated IE and includes the BWP-DownlinkDedicated IE in the RRC reconfiguration message. In some implementations, the base station 104 includes the UL configuration parameters in a BWP-UplinkDedicated IE and includes the BWP-UplinkDedicated IE in the RRC reconfiguration message.

In response to the RRC reconfiguration message, the UE 102 transmits 252. 254 an RRC reconfiguration complete message to the base station 104 via the TRPI 106a. In some implementations, the UE 102 may apply the DL and/or UL configuration parameters, upon receiving 250, 252 the RRC reconfiguration message, to the RRC reconfiguration complete message transmitted 252, 254 to the base station 104 via the TRP1 106a. In such implementations, the UE 102 performs 256 DL and/or UL communication with the base station 104 via the TRP2 106b in accordance with the DL and/or UL configuration parameters. The UE 102 can apply the first TA value and/or the first TAT for UL communication with the base station 104 via the TRP2 106b.

In some implementations, the UE 102 can apply different TA values and/or TAT for UL communication with the base station 104 via the TRP2 106b. In such cases, the UE 102 refrains from performing UL communication in accordance with the UL configuration parameters, until performing a TA value acquiring procedure 298 (e.g., random access procedure or MAC-CE indication) with the base station 104 via the TRP2 106b. In other implementations, the UE 102 refrains from performing DL communication with the base station 104 via the TRP2 106b, until performing the TA value acquiring procedure 298 with the base station 104 via the TRP2 106b. In some implementations, the base station 104 refrains from performing UL communication and/or configuring the UL configuration parameters, until after completing the TA value acquiring procedure 298 with the base station 104 via the TRP2 106b. In some implementations, the base station 104 refrains from performing DL communication and/or configuring the DL configuration parameters, until after completing the TA value acquiring procedure 298 with the base station 104 via the TRP2 106b.

In some implementations, the base station 104 can perform (additional) UL synchronization based on an indication in the RRC reconfiguration message, i.e., for communication with the base station 104 over the TRP2 106b. That is, the base station 104 configures the UE 102 to obtain (second) UL synchronization for communication between the UE 102 and TRPI 106a while maintaining the first UL synchronization for communication between the UE 102 and TRP2 106b. In other words, the base station 104 configures or indicates that the UE 102 maintains two TA values for communications between the UE 102 and the base station 104, i.e. between the UE 102 and the TRP1 106a and between the UE 102 and the TRP2 106b, respectively. In some implementations, the base station 104 can include, in the RRC reconfiguration message, a configuration (e.g., a field or IE), indicating (additional) UL synchronization is to be performed for communication between the UE 102 and the TRP2 106b. In other words, the configuration enables operation of two TA values for communications between the UE 102 and the base station 104, i.e. between the UE 102 and the TRP1 106a and between the UE 102 and the TRP2 106b, respectively.

In some implementations, the UE 102 initiates a second random access procedure 298 in response to the field or IE, before transmitting UL transmissions (e.g., CSI report, sounding reference signal (SRS), PUCCH transmissions, and/or PUSCH transmissions) to the base station 104 via the TRP2 106b. If the RRC reconfiguration message does not include the field or IE, the UE 102 does not initiate a second random access procedure 298 and can transmit UL transmissions (e.g., CSI report, sounding reference signal (SRS), PUCCH transmissions, and/or PUSCH transmissions) to the base station 104 via the TRP2 106b. In other implementations, the UE 102 refrains from transmitting UL transmissions (e.g., CSI report, sounding reference signal (SRS), PUCCH transmissions, and/or PUSCH transmissions) to the base station 104 via the TRP2 106b in response to the field or IE. In such cases, the UE 102 does not transmit a random access preamble to the base station 104 via the TRP2 106b until receiving 258, 260 a physical downlink control channel (PDCCH) order from the base station 104.

Elements 248, 250, 252, and 254 are collectively referred to in FIG. 2 as a TRP configuration procedure 296.

After receiving 236, 238 the RRC reconfiguration message via the TRP1 106a, or after performing the CSI resource configuration and CSI reporting procedure 294 or TRP configuration procedure 296 with the base station 104, the UE 102 can receive 262b, 264b a reference signal (RS) from the base station 104 via the TRP2 106b. The RS can be configured in the CSI resource configuration received 236, 238 from the base station 104, such that the UE 102 can receive 262b 264b the RS after receiving 238 the RRC reconfiguration message from the base station 104, or during or after the CSI resource configuration and CSI reporting procedure 294 or the TRP configuration procedure 296. After performing the TRP configuration procedure 296 with the base station 104, the UE 102 can initiate a random access procedure 298 via the TRP2 106b. In response to initiating the second random access procedure 298, the UE 102 transmits 266, 268 a second random access preamble on a time/frequency resource and a random access channel (RACH) occasion to the base station 104 via the TRP2 106b. In response to the second random access preamble, the base station 104 transmits 270, 272 a second random access response to the UE 102 via the TRP2 106b. The base station 104 includes a second preamble ID and a second TA command in the second random access response. The second preamble ID indicates the second random access preamble, and the second TA command includes a second TA value. The UE 102 applies the second TA value and determines or maintains 274 an uplink synchronized with the TRP2 106b after (e.g., in response to) applying the second TA value. The UE 102 applies the second TA value to transmit (subsequent) UL transmissions (e.g., PUCCH transmissions, PUSCH transmissions, and/or SRS transmissions) via the TRP2 106b until the UE 102 receives a new or different TA value from base station 104 that updates the second TA value.

In some implementations, the UE 102 starts a second TAT to maintain 274 or manage (second) UL synchronization (status) with the TRP2 106b or the base station 104 after or upon receiving the second TA command. In some implementations, the base station 104 includes an UL grant (i.e., a random access response (RAR) grant) in the second random access response and the UE 102 can transmit an UL MAC PDU to the base station 104 via the TRP2 106b in accordance with the UL grant. In cases where the second random access procedure 298 is a contention-based random access procedure, the UE 102 includes a cell-radio network temporary identifier (C-RNTI) of the UE 102 in the UL MAC PDU. The base station 104 identifies the UE 102 based on the C-RNTI. In response to the identification, the base station 104 generates a DCI and a cyclic redundancy check (CRC) for the DCI, scrambles the CRC with the C-RNTI and transmits the DCI and scrambled CRC on a PDCCH to the UE 102. In some implementations, the DCI includes an UL grant. Upon receiving the DCI and scrambled CRC on the PDCCH, the UE 102 determines that the content-based random access procedure is performed successfully. In cases where the second random access procedure 298 is a contention-free random access procedure, the UE 102 determines that the content-based random access procedure is performed successfully in response to receiving 270, 272 the second random access response message.

In some implementations, the base station 104 starts a second TAT to maintain 274 a second UL synchronization for UL and/or DL communication 276 with the UE 102 via the TRP2 106b, after (e.g., in response to) transmitting the second TA command to the UE 102. In some implementations, the TRPI 106a generates timing information for the second random access preamble received from the UE 102 and transmits the timing information to the base station 104. For example, the timing information can indicate a propagation delay or a propagation delay shift. Based on the timing information received from the TRP2 106b, the base station 104 determines the second TA value.

Elements 258, 260, 262b, 264b, 266, 268, 270, 272, and 274 are collectively referred to in FIG. 2 as the TA value acquiring procedure or the second random access procedure 298.

In some implementations, the UE 102 may suspend communication (e.g., reception of DL channel/RS or transmission of UL channel/RS) with the base station 104 via the TRPI 106a, while performing the second random access procedure 298. The UE 102 may suspend communication because the UE 102 is not capable of simultaneously performing the second random access procedure 298 based on an UL beam or a RS (i.e., toward a TRP) and communicating UL and DL transmissions (i.e., not related to random access procedures) based on another UL beam or RS (i.e., toward another TRP). In other implementations, the UE 102 continues communication with the base station 104 via the TRP2 106b, while performing the second random access procedure 298. After successfully completing the second random access procedure 298, the UE 102 performs 276 DL and UL communications with the BS 104 via TRP1 106a and TRP2 106b in accordance with the first TA value and the second TA value, respectively.

In some implementations, after receiving 252, 254 the RRC reconfiguration complete message from the UE 102, the base station 104 can transmit 258, 260 a PDCCH order to the UE 102 via the TRP2 106b to cause the UE 102 to initiate the second random access procedure 298 with the base station 104 via the TRP2 106b. In some implementations, the PDCCH order includes a reference signal index and a random access preamble index. Alternatively, the base station 104 can transmit the PDCCH order to the UE 102 via the TRPI 106a. In response to the PDCCH order, the UE 102 transmits 266, 268 the random access preamble to the base station 104 via the TRP2 106b. In some implementations, the random access preamble index includes (a value of) the second preamble ID identifying the second random access preamble. Thus, the UE 102 determines the second random access preamble in accordance with the random access preamble index. In other implementations, the random access preamble index includes a value indicating or instructing the UE 102 to determine a random access preamble by itself. Thus, the UE 102 determines the second random access preamble by (randomly) selecting it from the random access preambles configured in the system information.

In some implementations, the PDCCH order is a DCI. The base station 104 generates the DCI and a CRC for the DCI, scrambles the CRC with the C-RNTI and transmits the DCI and scrambled CRC to the TRP2 106b, e.g., via a fiber connection. In turn, the TRP2 106b transmits the DCI and the scrambled CRC on a PDCCH to the UE 102. In some implementations, the base station 104 transmits a first packet including the DCI and the scrambled CRC to the TRP2 106b. In some implementations, the base station 104 can transmit to the TRP2 106b control information configuring or indicating time and/or frequency resource for the PDCCH. In some implementations, the time and/or frequency resource can include subcarriers, resource elements or physical resource block(s) (PRBs). The TRP2 106b transmits the DCI and the scrambled CRC on the time and/or frequency resource in accordance with the control information. In implementations, the base station 104 includes the control information in the first packet. In other implementations, the base station 104 transmits to the TRP2 106b a second packet including the control information, instead of the first packet. In other implementations, the base station 104 does not transmit control information for the DCI and the scrambled CRC to the TRP2 106b. In such implementations, the TRP2 106b determines time and/or frequency resource for the PDCCH and transmits the DCI and the scrambled CRC on the time and/or frequency resource.

In some implementations, the RS index (e.g., SSB index) identifies one of the SSB(s). In some implementations, the base station 104 determines or decodes the SSB index indicated in the CSI report(s). In other implementations, the base station 104 determines or decodes the SSB index based on a radio resource (e.g., PUCCH resource) where the base station 104 receives 244, 246 one of the CSI report(s) for the SSB. In such implementations, the base station 104 can configure a different radio resource for the UE 102 to transmit a CSI report for each of the SSB(s). For example, the base station 104 can include, in the RRC reconfiguration message transmitted 236, 238 to the UE 102, a configuration that configures a different radio resource (e.g., PUCCH resource) for the UE 102 to transmit 244, 246 a CSI report for each of the SSB(s). In some implementations, the UE 102 can determine a time/frequency resource and/or a RACH occasion, based on the SSB (indicated in the RS index) and the random access configuration parameters received in the system information, and transmits 266, 268 the second random access preamble on the time/frequency resource and/or RACH occasion. In other implementations, the UE 102 can determine a time/frequency resource and/or a RACH occasion, based on the SSB (indicated in the RS index) and the random access configuration parameters received 248, 250 in the RRC reconfiguration message, and transmits 266, 268 the second random access preamble on the time/frequency resource and/or RACH occasion.

In other implementations, the RS index (e.g., CSI-RS index) identifies one of the CSI-RS(s). In some implementations, the base station 104 determines or decodes the CSI-RS index indicated in the CSI report(s). In other implementations, the base station 104 determines or decodes the CSI-RS index based on a radio resource (e.g., PUCCH resource) where the base station 104 receives 244, 246 the CSI report(s) for the CSI-RS. In such implementations, the base station 104 can configure a different radio resource for the UE 102 to transmit 244, 246 a CSI report for each of the CSI-RS(s). For example, the base station 104 can include, in the RRC reconfiguration message transmitted 236, 238 to the UE 102, a configuration that configures a different radio resource (e.g., PUCCH resource) for the UE 102 to transmit 244, 246 a CSI report for each of the CSI-RS(s). In some implementations, the UE 102 can determine a time/frequency resource and/or a RACH occasion, based on the CSI-RS (indicated in the RS index) and the random access configuration parameters in the RRC reconfiguration message that the UE 102 receives 248, 250 from the base station 104. The UE 102 transmits 266, 268 the second random access preamble on the time/frequency resource and/or RACH occasion. In some implementations, the random access configuration parameters indicate one or more associations between CSI-RS(s), and RACH occasion(s) and/or time/frequency resource(s).

In some implementations, the UE 102 determines transmission characteristics (e.g., spatial transmission filters/parameters) based on or referring to the RS index in PDCCH order and transmits 266 the second random access preamble to the TRP2 106b using the determined transmission characteristics. For example, the UE 102 can use reception characteristics of receiving 264b the RS identified by the RS index to derive the transmission characteristics. In some implementations, the transmission characteristics include phase, power, and/or transmission precoder. In some implementations, the UE 102 can further use the DL and/or UL configuration parameters of received 248, 250 from the base station 104 to determine the transmission characteristics. In other implementations, the UE 102 can use configuration parameters in the system information received 208, 210 from the base station 104 to determine the transmission characteristics. In some implementations, the UE 102 determines transmission characteristics (e.g., spatial transmission filters/parameters) not based on or not referring to the RS index in the PDCCH order and transmits 266. 268 the second random access preamble to the TRP2 106b using the determined transmission characteristics.

In some implementations, the UE 102 initiates the second random access procedure 298, in response to the random access configuration parameters received 248, 250 from the base station 104 and after receiving 262b, 264b the RS from the base station 104. In such implementations, the base station 104 does not transmit the PDCCH order to cause the UE 102 to perform the second random access procedure 298 In some implementations, the RRC reconfiguration message received 248, 250 from the base station 104 includes configuration parameters (e.g., PDCCH configuration, search space configuration and/or CORESET configuration) for the UE 102 to receive DL transmissions from the TRP2 106b. In some implementations, the UE 102 receives 270, 272 the second random access response in accordance with the configuration parameters. In other implementations, the system information received 208, 210 from the base station 104 includes configuration parameters (e.g., PDCCH configuration, search space configuration and/or CORESET configuration) for the UE 102 to receive 272 the second random access response from the TRP2 106b. In such implementations, the UE 102 receives 272 the second random access response in accordance with the configuration parameters. In some implementations, the UE 102 can use reception characteristics of receiving 264b the RS to receive 272 the second random access response from the TRP2 106b.

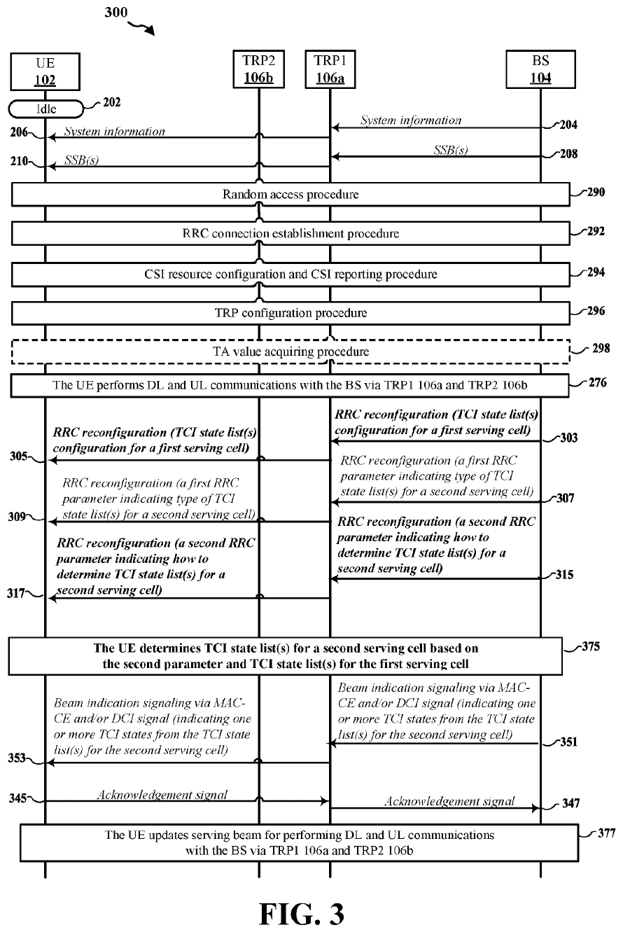

Although the TRP2 106b is used in the signaling diagram 200, the above description can be applied to a TRP3 106c, a TRP4 106d, etc., instead of the TRP2 106b. In such a cases, after successfully completing a random access procedure with the base station 104 via the TRP3 106c, the TRP4 106d, and another cell 102b-102e, similar to the second random access procedure 298, the UE 102 performs 256, 276 DL and UL communications with the BS 104 via the TRPs in accordance with the first TA value and second TA value, respectively. Accordingly, FIG. 2 describes procedures 290-298 that allow the UE 102 to communicate 276 with the base station 104 via multiple TRPs (mTRPs). FIG. 3 describes procedures for determining 375 TCI state lists for the mTRPs.

FIG. 3 illustrates a signaling diagram 300 for determining one or more TCI state lists associated with mTRPs. Elements 202, 204, 206, 208, 210, 276, 290, 292, 294, 296, and 298 of FIG. 3 have already been described with respect FIG. 2.

After the UE 102 performs 276 the DL and/or UL communication with the base station 104, the UE 102 can receive, from the base station 104, a serving cell configuration for configuring a first serving cell, a second serving cell, a third serving cell, etc. In some implementations, the first serving cell may be a reference cell that an entity associated with the second serving cell might be able to use as a reference for determining a TCI state list for the second serving cell. In the signaling diagram 300, the base station 104 can transmit 303, 305 an RRC (re)configuration message to the UE 102 via the TRPI 106a. The RRC (re)configuration message can include a TCI state list(s) configuration for the first serving cell. In other implementations, the base station 104 can transmit (not shown) the RRC (re)configuration message to the UE 102 via the TRP2 106b.

The base station 104 might transmit 303, 305 an RRC message (e.g., RRCReconfiguration message) to the UE 102 to configure a TCI state pool for the first serving cell. “TCI state pool” refers to a group/list of TCI states from which the base station 104 can select a TCI state for indicating a beam. In implementations, the base station 104 may use a MAC-CE or DCI to indicate a TCI state from the TCI state pool. The UE 102 applies the indicated TCI state from the TCI state pool for performing 276, 377 the DL and UL communications with the base station 104 via the TRP1 106a and the TRP2 106b. The UE 102 can determine the TCI state pool for a second serving cell based on referencing the first serving cell, which may be referred to as a reference cell/component carrier (CC). Thus, the base station 104 might not explicitly configure the TCI state pool for the second serving cell via a ServingCellConfig for the second serving cell.

The TCI state pool may correspond to a joint TCI state pool or separate TCI state pools. For the joint TCI state pool, the UE 102 applies a same TCI state to both DL and UL channels/reference signals. For the separate TCI state pools, the UE 102 applies a DL TCI state to DL channels/reference signals and a separate UL TCI state to UL channels/reference signals. The base station 104 might apply a unified TCI framework for indicating a TCI state in certain examples associated with a single TRP. For example, from a perspective of the UE 102, channel transmissions, reference signals, etc., might be transmitted toward or received from the single TRP, such that the UE 102 might determine a single TCI state associated with the single TRP. Although the unified TCI framework might be an efficient technique for indicating beams in single TRP use cases, other examples associated with m TRPs might include additional complexities for indicating the TCI state lists for the serving cells of the mTRPs.

In a first example based on mTRPs of a same serving cell/CC, the joint/separate TCI state lists might indicate TCI states for both the TRP1 106a and the TRP2 106b in a same TCI state list, rather than indicating joint/separate TCI states that correspond to only one of the TRPs 106a, 106b. That is, a joint TCI state list for the mTRPs might include a first joint TCI state for the TRP1 106a and a second joint TCI state for the TRP2 106b in a single joint TCI state list. Similarly, the separate TCI state lists for the mTRPs might include a single DL TCI state list that applies to both the TRPI 106a and the TRP2 106b as well as a single UL TCI state list that applies to both the TRPI 106a and the TRP2 106b.

In a second example based on the mTRPs of the same serving cell/CC, the joint/separate TCI state lists might be configured as two joint/separate TCI state lists that respectively correspond to the TRP1 106a and the TRP2 106b. That is, joint TCI state lists for the mTRPs might include a first joint TCI state list for the TRPI 106a and a second joint TCI state list for the TRP2 106b. Similarly, the separate TCI state lists for the mTRPs might include a first DL TCI state list that applies to the TRPI 106a and a second DL TCI state list that applies to the TRP2 106b as well as a first UL TCI state list that applies to the TRP1 106a and a second UL TCI state list that applies to the TRP2 106b.

The base station 104 can transmit 307, 309 the RRC (re)configuration message to the UE 102 via the TRP1 106a or the TRP2 106b. The RRC (re)configuration message can include a first RRC parameter indicating a type of TCI state list(s) for the second serving cell, where the type may correspond to a joint TCI state list or separate TCI state lists. The base station 104 can further transmit 315, 317a second RRC parameter in a same or different RRC (re)configuration message to the UE 102 via the TRP1 106a or the TRP2 106b. The RRC (re)configuration message can include or configure TCI state list(s) configuration for the second serving cell. That is, the second RRC parameter in the RRC (re)configuration message might indicate to the UE 102 how to determine TCI state list(s) for the second serving cell. For example, the second RRC parameter that the UE 102 receives 315, 317 from the base station 104 may at least indicate a serving cell index of the first serving cell and, optionally, a bitmap indicating TCI state ID(s) of TCI state(s) in the first TCI state list. In some cases, instead of indicating a bitmap, the second RRC parameter can use other parameters or information for the UE 102 to determine TCI state list(s) for the second serving cell. In further implementations, the second RRC parameter that the UE 102 receives 315, 317 from the base station 104 may indicate an additional serving cell index of the third serving cell. In still further implementations, the second RRC parameter that the UE 102 receives 315, 317 from the base station 104 may indicate a TCI state list ID for one of the second TCI state list or the third TCI state list. In response to receiving an RRC (re)configuration message from the base station 104, the UE 102 can transmit (not shown) an RRC (re)configuration complete message to the base station 104 via the TRP1 106a or the TRP2 106b.

Some implementations might limit CCs associated with single TRPs from sharing same TCI states with CCs associated with mTRPs. That is, if a CC1 corresponds to a reference cell associated with mTRPs, then a CC2 that uses CC1 as a reference should also be associated with mTRPs. Likewise, if the CC1 corresponds to the reference cell but is associated with a single TRP, then the CC2 that uses the CC1 as a reference should also be associated with a single TRP.

Other implementations might allow CCs associated with single TRPs to share same TCI states with CCs associated with mTRPs. For example, a CC1 that corresponds to a reference cell associated with mTRPs might be used as a reference for a CC2 that corresponds to a single TRP, or a CC1 that corresponds to a reference cell associated with a single TRP might be used as a reference for a CC2 that corresponds to mTRPs. In further implementations, additional CCs, such as a CC3 that corresponds to a second reference cell associated with a single TRP, might be used as a reference for the CC2 associated with the mTRPs.

For a TCI state list that includes first/second joint TCI states for the mTRPs in a single list, or separate DL/UL TCI states for the mTRPs in combined DL/UL TCI state lists for the mTRPs, the second parameter (e.g., unifiedTCI-StateRef) that the UE 102 receives 315, 317 from the base station 104 may indicate one or two cell ID(s), At least when indicating one cell ID, the second parameter (e.g., unifiedTCI-StateRef) may further indicate a portion of the TCI list in a reference CC for TCI index ordering of the mTRPs. The second parameter (e.g., unifiedTCI-StateRef) may further include a bitmap to indicate TCI state IDs. When indicating two cell IDs, the second parameter may indicate whether a reference TCI list is for one TRP or both TRPs, and a TCI ID reorder procedure for the TCI states. In examples, the reference CC is associated with mTRPs.

For two joint TCI state lists, or two sets of separate DL/UL TCI state lists, that correspond to respective TRPs of the mTRPs, the second parameter (e.g., unifiedTCI-StateRef) that the UE 102 receives 315, 317 from the base station 104 may indicate one or two cell ID(s). At least when indicating one cell ID, the second parameter (e.g., unifiedTCI-StateRef) may further indicate a TCI list ID. When indicating two cell IDs, the second parameter (e.g., unifiedTCI-StateRef) can indicate to the UE 102 that the TCI lists for the two reference cells are related to the same TRP and/or that a reference cell is configured with two TCI lists. In examples, the reference CC is associated with mTRPs.

After receiving 303-317 the RRC (re)configuration messages from the base station 102 via the TRP1 106a or the TRP2 106b, the UE 102 determine 375 TCI state list(s) for a second serving cell based on the second parameter and the TCI state list(s) for the first serving cell. In examples, the TCI state list(s) for the second serving cell can be a subset of the first TCI state list for the first serving cell.

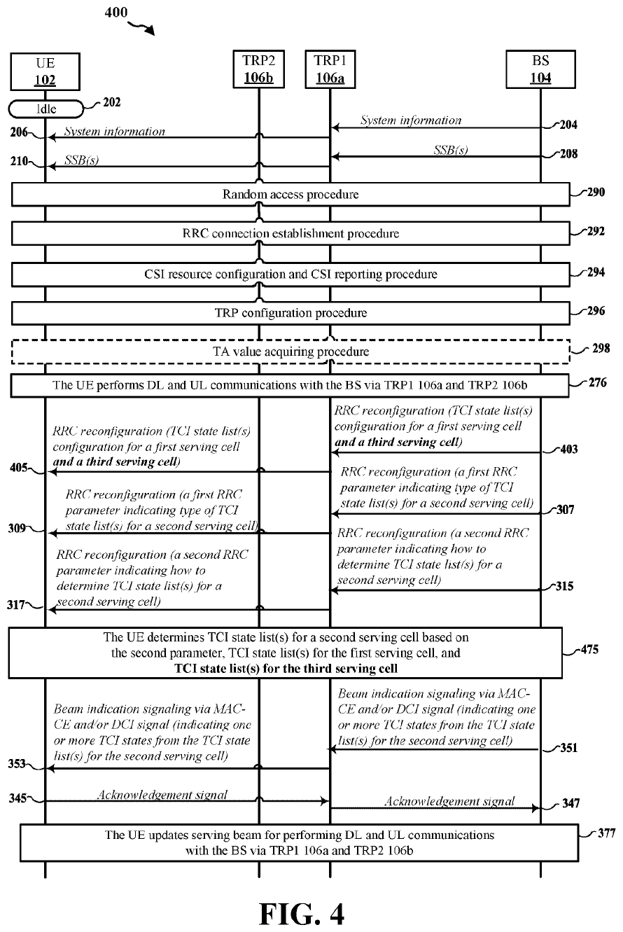

The base station 104 can then transmit 351, 353 beam indication signaling to the UE 102 via the TRP1 106a or the TRP2 106b. The beam indication signal can be transmitted 351, 353 by the base station 104 via a MAC-CE and/or a DCI. The beam indication signal can indicate one or more TCI states from the TCI state list(s) for the second serving cell. In response to receiving 351, 353 the beam indication signaling, the UE 102 can transmit 345, 347 an acknowledgement (ACK) signal to the base station 104 via the TRP1 106a or the TRP2 106b. In response to transmitting 345, 347 the ACK to the base station 104, the UE 102 can update 377 a serving beam for performing DL and UL communications with the base station 104 via the TRPI 106a and the TRP2 106b. For example, the UE 102 may receive a DL transmission from the base station 104 or transmit an UL transmission to the base station 104 via the one or more TCI state(s) in a slot after an application time period. In some implementations, such as described with respect to FIG. 3, the TCI state list determination procedure might be based on a single reference cell. In other implementations, such as described with respect to FIG. 4, the TCI state list determination procedure might be based on a plurality of reference cells.

FIG. 4 illustrates a signaling diagram 400 for determining one or more TCI state lists based on multiple reference cells. Elements 202, 204, 206, 208, 210, 276, 290, 292, 294, 296, and 298 of FIG. 4 have already been described with respect FIG. 2. Further, elements 307, 309, 315, 317, 351, 353, 345, 347, and 377 of FIG. 4 have already been described with respect to FIG. 3.

The base station 104 can transmit 403, 405 an RRC (re)configuration message to the UE 102 via the TRPI 106a or the TRP2 106b. The RRC (re)configuration message can include TCI state list(s) configuration for the first serving cell (similar to 303, 305 of FIG. 3) as well as TCI state list(s) configuration for the third serving cell, where both the first serving cell and the third serving cell correspond to reference cells. The TCI state list(s) configurations might be associated with the same or different CCs. The RRC (re)configuration message can be a single RRC (re)configuration message or combined with one or more other RRC (re)configuration messages. In response to receiving 403-405, 307-317 the RRC (re)configuration messages from the base station 104, the UE 102 can transmit an RRC (re)configuration complete message(s) to the base station 104 via the TRPI 106a or the TRP2 106b.

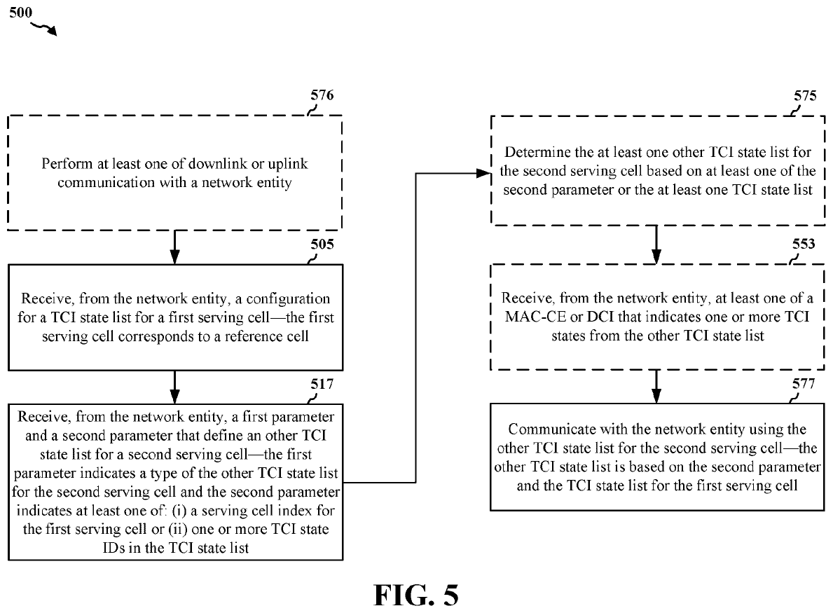

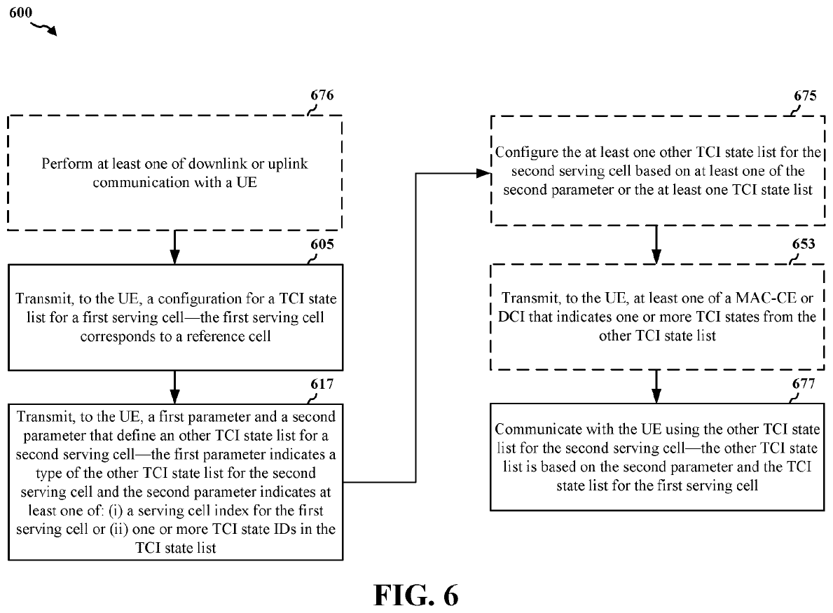

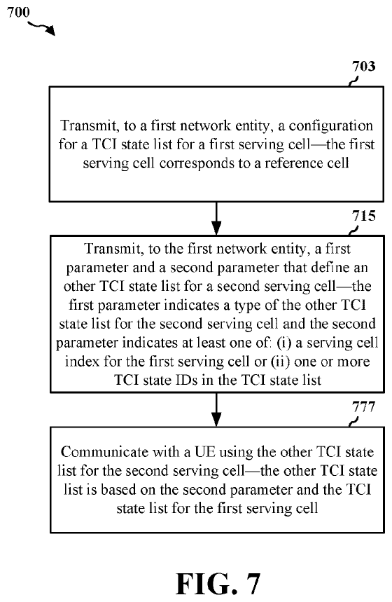

The UE 102 determines 475 the TCI state list(s) for the second serving cell based on the second parameter, the TCI state list(s) for the first serving cell, and the TCI state list(s) for the third serving cell. In examples, the TCI state list(s) for the second serving cell can be a combination of the first TCI state list(s) for the first serving cell and the third TCI state list(s) for the third serving cell. The UE 102 might determine 475 the TCI state list for the second/third serving cells based on the second/third TCI state lists, if the TCI state list ID indicates the second/third TCI state lists. In further implementations, the UE 102 might determine 475 the TCI state list for the second serving cell based on the second RRC parameter and the third TCI state list. FIGS. 2-4 illustrate signaling procedures associated with mTRPs. FIGS. 5-7 show methods for implementing one or more aspects of FIGS. 2-4. In particular, FIG. 5 shows an implementation by the UE 102 of the one or more aspects of FIGS. 2-4. FIG. 6 shows an implementation by a TRP 106a-106b of the one or more aspects of FIGS. 2-4. FIG. 7 shows an implementation by the base station 104 of the one or more aspects of FIGS. 2-4.

FIG. 5 illustrates a flowchart 500 of a method of wireless communication at a UE. With reference to FIGS. 1-4 and 8, the method may be performed by the UE 102, the UE apparatus 802, etc., which may include the memory 824′ and which may correspond to the entire UE 102 or the UE apparatus 802, or a component of the UE 102 or the UE apparatus 802, such as the wireless baseband processor 824, and/or the application processor 806.

The UE 102 performs 576 at least one of downlink or uplink communication with a network entity. For example, referring to FIGS. 2-4, the UE 102 performs 276 DL or UL communications with the base station 104 via the TRP1 106a and the TRP2 106b. Referring again to FIG. 2, the UE 102 also performs 256 DL and/or UL communications with the base station 104 via the TRP1 106a and via the TRP2 106b.

The UE 102 receives 505, from the network entity, a configuration for a TCI state list for a first serving cell-the first serving cell corresponds to a reference cell. For example, referring to FIG. 3, the UE 102 receives 305 an RRC configuration from the TRP1 106a that indicates a TCI state list(s) configuration for a first serving cell (e.g., reference cell). Referring to FIG. 4, the UE 102 receives 405 an RRC configuration from the TRP1 106a that indicates a TCI state list(s) configuration for a first serving cell (e.g., first reference cell) and a third serving cell (e.g., second reference cell).

The UE 102 receives 517, from the network entity, a first parameter and a second parameter that define an other TCI state list for a second serving cell-the first parameter indicates a type of the other TCI state list for the second serving cell and the second parameter indicates at least one of: (i) a serving cell index for the first serving cell or (ii) one or more TCI state IDs in the TCI state list. For example, referring to FIGS. 3-4, the UE 102 receives 309 an RRC configuration including a first RRC parameter indicating a type (e.g., joint/separate) of TCI state list(s) for a second serving cell. The UE 102 also receives 317 an RRC configuration including a second RRC parameter indicating how to determine TCI state list(s) for the second serving cell.

The UE 102 determines 575 the at least one other TCI state list for the second serving cell based on at least one of the second parameter or the at least one TCI state list. For example, referring to FIG. 3, the UE 102 determines 375 TCI state list(s) for a second serving cell based on the second parameter and TCI state list(s) for the first serving cell. Referring to FIG. 4, UE 102 determines 475 TCI state list(s) for a second serving cell based on the second parameter, TCI state list(s) for the first serving cell, and TCI state list(s) for the third serving cell.

The UE 102 receives 553, from the network entity, at least one of a MAC-CE or DCI that indicates one or more TCI states from the other TCI state list. For example, referring to FIGS. 3-4, the UE 102 receives 353 beam indication signaling from the TRP1 106a via MAC-CE and/or DCI signaling. The beam indication signaling can indicate one or more TCI states from the TCI state list(s) for the second serving cell.

The UE 102 communicates 577 with the network entity using the other TCI state list for the second serving cell—the other TCI state list is based on the second parameter and the TCI state list for the first serving cell. For example, referring to FIGS. 3-4, the UE 102 updates a serving beam for performing 377 communications with the base station 104 via the TRP1 106a and the TRP2 106b. The communication is based on the determined 375, 475 TCI state list(s) for the second serving cell. FIG. 5 describes a method from a UE-side of a wireless communication link, whereas FIGS. 6-7 describe methods from a network-side of the wireless communication link.

FIG. 6 is a flowchart 600 of a method of wireless communication at a network entity. With reference to FIGS. 1-4 and 9, the method may be performed by network entities, such as the TRPs 106a-106b, which may correspond to the RU 106, the DU 108, the CU 110, an RU processor 942, a DU processor 932, a CU processor 912, etc. The network entities/TRPs 106a-106b may include the memory 912′/932′/942′, which may correspond to an entirety of the network entities/TRPs 106a-106b or a component of the network entities/TRPs 106a-106b, such as the RU processor 942, the DU processor 932, or the CU processor 912.

The network entity/TRP1 106a performs 676 at least one of downlink or uplink communication with a UE. For example, referring to FIGS. 2-4, the TRPI 106a performs 276 DL or UL communications with the UE 102. Referring again to FIG. 2, the TRP1 106a also performs 256 DL and/or UL communications with the UE 102.

The network entity/TRP1 106a transmits 605, to the UE, a configuration for a TCI state list for a first serving cell—the first serving cell corresponds to a reference cell. For example, referring to FIG. 3, the TRP1 106a transmits 305 an RRC configuration to the UE 102 that indicates a TCI state list(s) configuration for a first serving cell (e.g., reference cell). Referring to FIG. 4, the TRP1 106a transmits 405 an RRC configuration to the UE 102 that indicates a TCI state list(s) configuration for a first serving cell (e.g., first reference cell) and a third serving cell (e.g., second reference cell).

The network entity/TRP1 106a transmits 617, to the UE, a first parameter and a second parameter that define an other TCI state list for a second serving cell-the first parameter indicates a type of the other TCI state list for the second serving cell and the second parameter indicates at least one of: (i) a serving cell index for the first serving cell or (ii) one or more TCI state IDs in the TCI state list. For example, referring to FIGS. 3-4, the TRPI 106a transmits 309, to the UE 102, an RRC configuration including a first RRC parameter indicating a type (e.g., joint/separate) of TCI state list(s) for a second serving cell. The TRPI 106a also transmits 317, to the UE 102, an RRC configuration including a second RRC parameter indicating how to determine TCI state list(s) for the second serving cell.

The network entity/TRP1 106a determines or configures 675 the at least one other TCI state list for the second serving cell based on at least one of the second parameter or the at least one TCI state list. For example, referring to FIG. 3, the TRPI 106a configures or determines 375 TCI state list(s) for a second serving cell based on the second parameter and TCI state list(s) for the first serving cell. Referring to FIG. 4, the TRP1 106a configures or determines 475 TCI state list(s) for a second serving cell based on the second parameter, TCI state list(s) for the first serving cell, and TCI state list(s) for the third serving cell.

The network entity/TRP1 106a transmits 653, to the UE, at least one of a MAC-CE or DCI that indicates one or more TCI states from the other TCI state list. For example, referring to FIGS. 3-4, the TRP1 106a transmits 353 beam indication signaling to the UE 102 via MAC-CE and/or DCI signaling. The beam indication signaling can indicate one or more TCI states from the TCI state list(s) for the second serving cell.

The network entity/TRP1 106a communicates 677 with the UE using the other TCI state list for the second serving cell—the other TCI state list is based on the second parameter and the TCI state list for the first serving cell. For example, referring to FIGS. 3-4, the TRP1 106a communicates 377 with the UE 102 based on an updated serving beam of the UE 102. The communication 377 is based on determined 375, 475 TCI state list(s) for the second serving cell. FIG. 6 describes a method from a perspective of the TRPs 106a-106b, whereas FIG. 7 describe methods from a perspective of the base station 104.

FIG. 7 is a flowchart 700 of a method of wireless communication at a second network entity. With reference to FIGS. 1-4 and 9, the method may be performed by the base station 104, which may correspond to the RU 106, the DU 108, the CU 110, an RU processor 942, a DU processor 932, a CU processor 912, etc. The base station 104 may include the memory 912′/932′/942′, which may correspond to an entirety of the base station 104, or a component of the base station 104, such as the RU processor 942, the DU processor 932, or the CU processor 912.

The second network entity 104 transmits 703, to a first network entity, a configuration for a TCI state list for a first serving cell-the first serving cell corresponds to a reference cell. For example, referring to FIG. 3, the base station 104 transmits 303 an RRC configuration to the UE 102 via the TRP1 106a and the TRP2 106b that indicates a TCI state list(s) configuration for a first serving cell (e.g., reference cell). Referring to FIG. 4, the base station 104 transmits 403 an RRC configuration to the UE 102 via the TRP1 106a and the TRP2 106b that indicates a TCI state list(s) configuration for a first serving cell (e.g., first reference cell) and a third serving cell (e.g., second reference cell).

The second network entity 104 transmits 715, to the first network entity, a first parameter and a second parameter that define an other TCI state list for a second serving cell—the first parameter indicates a type of the other TCI state list for the second serving cell and the second parameter indicates at least one of: (i) a serving cell index for the first serving cell or (ii) one or more TCI state IDs in the TCI state list. For example, referring to FIGS. 3-4, the base station 104 transmits 307, to the UE 102 via the TRP1 106a and the TRP2 106b, an RRC configuration including a first RRC parameter indicating a type (e.g., joint/separate) of TCI state list(s) for a second serving cell. The base station 104 also transmits 315, to the UE 102 via the TRP1 106a and the TRP2 106b, an RRC configuration including a second RRC parameter indicating how to determine TCI state list(s) for the second serving cell.

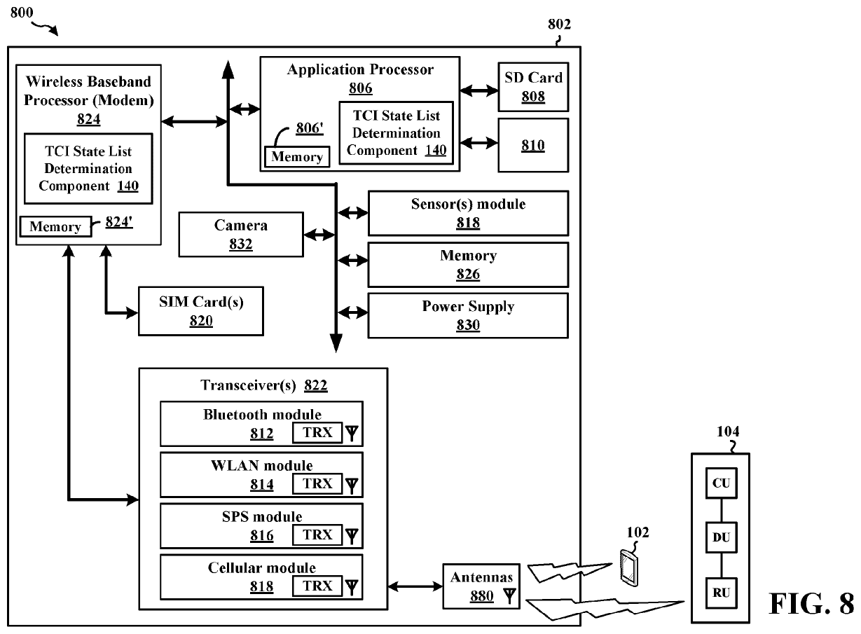

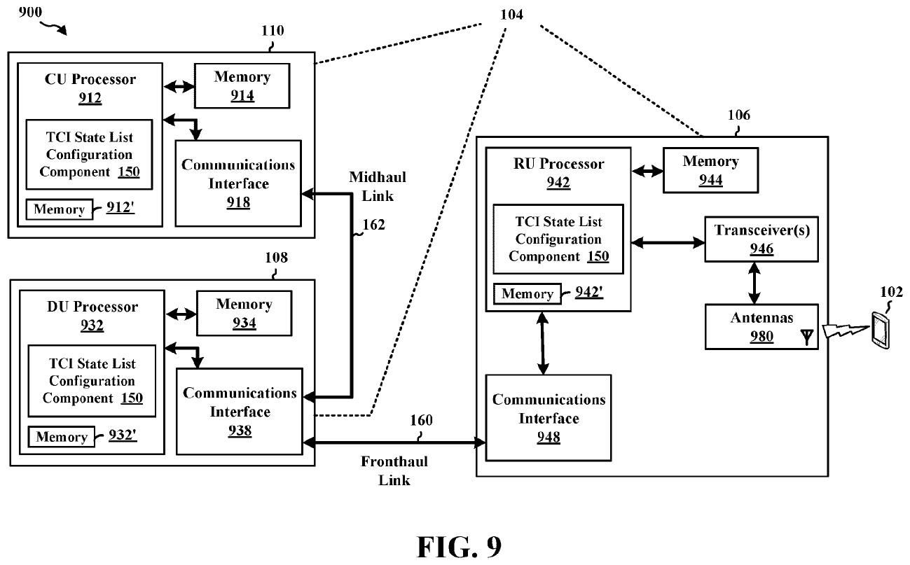

The second network entity 104 communicates 777 with a UE using the other TCI state list for the second serving cell-the other TCI state list is based on the second parameter and the TCI state list for the first serving cell. For example, referring to FIGS. 3-4, the base station 104 communicates 377 with the UE 102 via the TRP1 106a and the TRP2 106b based on an updated serving beam of the UE 102. The communication 377 is based on determined 375, 475 TCI state list(s) for the second serving cell. A UE apparatus 802, as described in FIG. 8, may perform the method of flowchart 500. The one or more network entities 104, as described in FIG. 9, may perform the methods of flowcharts 600-700.

FIG. 8 is a diagram 800 illustrating an example of a hardware implementation for a UE apparatus 802. The apparatus 802 may be the UE 102, a component of the UE, or may implement UE functionality. In some aspects, the apparatus 802 may include a wireless baseband processor 824 (also referred to as a modem) coupled to one or more transceivers 822 (e.g., wireless RF transceiver). The wireless baseband processor 824 may include on-chip memory 824′. In some aspects, the apparatus 802 may further include one or more subscriber identity modules (SIM) cards 820 and an application processor 806 coupled to a secure digital (SD) card 808 and a screen 810. The application processor 806 may include on-chip memory 806′.

The apparatus 802 may further include a Bluetooth module 812, a WLAN module 814, an SPS module 816 (e.g., GNSS module), and a cellular module 817 within the one or more transceivers 822. The Bluetooth module 812, the WLAN module 814, the SPS module 816, and the cellular module 817 may include an on-chip transceiver (TRX) (or in some cases, just a receiver (RX)). The Bluetooth module 812, the WLAN module 814, the SPS module 816, and the cellular module 817 may include their own dedicated antennas and/or utilize the antennas 880 for communication. The apparatus 802 may further include one or more sensor modules 818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 826, a power supply 830, and/or a camera 832.

The wireless baseband processor 824 communicates through the transceiver(s) 822 via one or more antennas 880 with another UE 102 and/or with an RU associated with a network entity 104. The wireless baseband processor 824 and the application processor 806 may each include a computer-readable medium/memory 824′, 806′, respectively. The additional modules of memory 826 may also be considered a computer-readable medium/memory. Each computer-readable medium/memory 824′, 806′, 826 may be non-transitory. The wireless baseband processor 824 and the application processor 806 are each responsible for general processing, including the execution of software stored on the computer-readable medium/memory. The software, when executed by the wireless baseband processor 824/application processor 806, causes the wireless baseband processor 824/application processor 806 to perform the various functions described. The computer-readable medium/memory may also be used for storing data that is manipulated by the wireless baseband processor 824/application processor 806 when executing software. The wireless baseband processor 824/application processor 806 may be a component of the UE 102. The apparatus 802 may be a processor chip (modem and/or application) and include just the wireless baseband processor 824 and/or the application processor 806, and in another configuration, the apparatus 802 may be the entire UE 102 and include the additional modules of the apparatus 802.

As discussed, the TCI state list determination component 140 is configured to receive, from a network entity, a configuration for a transmission configuration indicator (TCI) state list for a first serving cell, the first serving cell corresponding to a reference cell; receive, from the network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state identifiers (IDs) in the TCI state list; and communicate with the network entity using the other TCI state list for the second serving cell, the other TCI state list based on the second parameter and the TCI state list for the first serving cell. The TCI state list determination component 140 may be within the wireless baseband processor 824, the application processor 806, or both the wireless baseband processor 824 and the application processor 806. The TCI state list determination component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 802 may include a variety of components configured for various functions. In one configuration, the apparatus 802, and in particular the wireless baseband processor 824 and/or the application processor 806, includes means for receiving, from a network entity, a configuration for a TCI state list for a first serving cell, the first serving cell corresponding to a reference cell; means for receiving, from the network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and means for communicating with the network entity using the other TCI state list for the second serving cell, the other TCI state list based on the second parameter and the TCI state list for the first serving cell. The apparatus 802 further includes means for performing at least one of downlink or uplink communication with a network entity. The apparatus 802 further includes means for determining the at least one other TCI state list for the second serving cell based on at least one of the second parameter or the at least one TCI state list. The apparatus 802 further includes means for receiving, from the network entity, at least one of a MAC-CE or DCI that indicates one or more TCI states from the other TCI state list. The means may be the TCI state list determination component 140 of the apparatus 802 configured to perform the functions recited by the means.

FIG. 9 is a diagram 900 illustrating an example of a hardware implementation for one or more network entities 104. The one or more network entities 104 may be a BS, a component of a BS, or may implement BS functionality. The one or more network entities 104 may include at least one of a CU 110, a DU 108, or an RU 106. For example, the TCI state list configuration component 150 may sit at the one or more network entities 104, such as the CU 110; both the CU 110 and the DU 108; each of the CU 110, the DU 108, and the RU 106; the DU 108; both the DU 108 and the RU 106; or the RU 106.

The CU 110 may include a CU processor 912. The CU processor 912 may include on-chip memory 912′. In some aspects, the CU 110 may further include additional memory modules 914 and a communications interface 918. The CU 110 communicates with the DU 108 through a midhaul link 162, such as an FI interface. The DU 108 may include a DU processor 932. The DU processor 932 may include on-chip memory 932′. In some aspects, the DU 108 may further include additional memory modules 934 and a communications interface 938. The DU 108 communicates with the RU 106 through a fronthaul link 160. The RU 106 may include an RU processor 942. The RU processor 942 may include on-chip memory 942′. In some aspects, the RU 106 may further include additional memory modules 944, one or more transceivers 946, antennas 980, and a communications interface 948. The RU 106 communicates wirelessly with the UE 102.

The on-chip memory 912′, 932′, 942′ and the additional memory modules 914, 934, 944 may each be considered a computer-readable medium/memory. Each computer-readable medium/memory may be non-transitory. Each of the processors 912, 932, 942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed, the TCI state list configuration component 150 is configured to transmit, to a UE, a configuration for a TCI state list for a first serving cell, the first serving cell corresponding to a reference cell; transmit, to the UE, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and communicate with the UE using the other TCI state list for the second serving cell, the other TCI state list based on the second parameter and the TCI state list for the first serving cell. The TCI state list configuration component 150 is further configured to transmit, to a first network entity, a configuration for a TCI state list for a first serving cell, the first serving cell corresponding to a reference cell; transmit, to the first network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state identifiers (IDs) in the TCI state list; and communicate with a UE using the other TCI state list for the second serving cell, the other TCI state list based on the second parameter and the TCI state list for the first serving cell. The TCI state list configuration component 150 may be within one or more processors of one or more of the CU 110, DU 108, and the RU 106. The TCI state list configuration component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a UE, a configuration for a TCI state list for a first serving cell, the first serving cell corresponding to a reference cell; means for transmitting, to the UE, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and means for communicating with the UE using the other TCI state list for the second serving cell, the other TCI state list based on the second parameter and the TCI state list for the first serving cell. The one or more network entities 104 further include means for performing at least one of downlink or uplink communication with a UE. The one or more network entities 104 further include means for configuring the at least one other TCI state list for the second serving cell based on at least one of the second parameter or the at least one TCI state list. The one or more network entities 104 further include means for transmitting, to the UE, at least one of a MAC-CE or DCI that indicates one or more TCI states from the other TCI state list.

In further configurations, the one or more network entities 104 further include means for transmitting, to a first network entity, a configuration for a TCI state list for a first serving cell, the first serving cell corresponding to a reference cell; means for transmitting, to the first network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and means for communicating with a UE using the other TCI state list for the second serving cell, the other TCI state list based on the second parameter and the TCI state list for the first serving cell. The means may be the TCI state list configuration component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for a TCI state list for a first serving cell, the first serving cell corresponding to a reference cell; receiving, from the network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and communicating with the network entity using the other TCI state list for the second serving cell, the other TCI state list based on the second parameter and the TCI state list for the first serving cell.

Example 2 may be combined with example 1 and includes that the configuration for the TCI state list is further for a third serving cell, the third serving cell corresponding to a second reference cell.

Example 3 may be combined with example 1 and includes that the other TCI state list for the second serving cell is further based on the TCI state list for a third serving cell, the third serving cell corresponding to a second reference cell.

Example 4 may be combined with any of examples 2-3 and includes that the second parameter indicates the serving cell index and the serving cell index further indicates the third serving cell.

Example 5 may be combined with any of examples 2-4 and includes that the other TCI state list for the second serving cell is further based on a combination of the TCI state list for the first serving cell and the third serving cell.

Example 6 may be combined with any of examples 1-4 and includes that the other TCI state list for the second serving cell corresponds to a subset of the TCI state list for the first serving cell.

Example 7 may be combined with any of examples 1-6 and includes that the TCI state list for the first serving cell includes one or more combined TCI state lists that correspond to both a first TRP and a second TRP.

Example 8 may be combined with example 7 and includes that the one or more combined TCI state lists correspond to at least one of a joint TCI state list, a downlink TCI state list, or an uplink TCI state list.

Example 9 may be combined with any of examples 1-6 and includes that the second parameter indicates the one or more TCI state IDs and the TCI state list for the first serving cell includes one or more first TCI state lists for a first TRP that are separate from one or more second TCI state lists for a second TRP.

Example 10 may be combined with example 9 and includes that a TCI state ID of the one or more TCI state IDs corresponds to the one or more first TCI state lists for the first TRP or the one or more second TCI state lists for the second TRP.

Example 11 may be combined with example 10 and includes that the TCI state ID corresponds to the one or more first TCI state lists for the first TRP, and includes that the other TCI state list for the second serving cell is based on at least one of the one or more first TCI state lists for the first TRP or the second parameter.

Example 12 may be combined with any of examples 1-11 and further includes receiving, from the network entity, at least one of a MAC-CE or DCI that indicates one or more TCI states from the other TCI state list.

Example 13 may be combined with any of examples 1-12 and includes that the TCI state list and the other TCI state list correspond to any of: (a) a joint type of TCI state lists for mTRPs, or (b) a separate type of TCI state lists for the mTRPs.

Example 14 is a method of wireless communication at a network entity, including: transmitting, to a UE, a configuration for a TCI state list for a first serving cell, the first serving cell corresponding to a reference cell; transmitting, to the UE, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and communicating with the UE using the other TCI state list for the second serving cell, the other TCI state list based on the second parameter and the TCI state list for the first serving cell.

Example 15 may be combined with example 14 and includes that the configuration for the TCI state list is further for a third serving cell, the third serving cell corresponding to a second reference cell.

Example 16 may be combined with example 14 and includes that the other TCI state list for the second serving cell is further based on the TCI state list for a third serving cell, the third serving cell corresponding to a second reference cell.

Example 17 may be combined with any of examples 15-16 and includes that the second parameter indicates the serving cell index and the serving cell index further indicates the third serving cell.

Example 18 may be combined with any of examples 15-17 and includes that the other TCI state list for the second serving cell is further based on a combination of the TCI state list for the first serving cell and the third serving cell.

Example 19 may be combined with any of examples 14-17 and includes that the other TCI state list for the second serving cell corresponds to a subset of the TCI state list for the first serving cell.

Example 20 may be combined with any of examples 14-19 and includes that the TCI state list for the first serving cell includes one or more combined TCI state lists that correspond to both a first TRP and a second TRP.

Example 21 may be combined with example 20 and includes that the one or more combined TCI state lists correspond to at least one of a joint TCI state list, a downlink TCI state list, or an uplink TCI state list.

Example 22 may be combined with any of examples 14-19 and includes that the second parameter indicates the one or more TCI state IDs and the TCI state list for the first serving cell includes one or more first TCI state lists for a first TRP that are separate from one or more second TCI state lists for a second TRP.

Example 23 may be combined with example 22 and includes that a TCI state ID of the one or more TCI state IDs corresponds to the one or more first TCI state lists for the first TRP or the one or more second TCI state lists for the second TRP.

Example 24 may be combined with example 23 and includes that the TCI state ID corresponds to the one or more first TCI state lists for the first TRP, and includes that the other TCI state list for the second serving cell is based on at least one of the one or more first TCI state lists for the first TRP or the second parameter.

Example 25 may be combined with any of examples 14-24 and further includes transmitting, to the UE, at least one of a MAC-CE or DCI that indicates one or more TCI states from the other TCI state list.

Example 26 may be combined with any of examples 14-25 and includes that the TCI state list and the other TCI state list correspond to any of: (a) a joint type of TCI state lists for mTRPs, or (b) a separate type of TCI state lists for the mTRPs.

Example 27 is a method of wireless communication at a second network entity, including: transmitting, to a first network entity, a configuration for a TCI state list for a first serving cell, the first serving cell corresponding to a reference cell; transmitting, to the first network entity, a first parameter and a second parameter that define an other TCI state list for a second serving cell, the first parameter indicating a type of the other TCI state list for the second serving cell, the second parameter indicating at least one of: (i) a serving cell index for the first serving cell, or (ii) one or more TCI state IDs in the TCI state list; and communicating with a UE using the other TCI state list for the second serving cell, the other TCI state list based on the second parameter and the TCI state list for the first serving cell.

Example 28 is an apparatus for wireless communication for implementing a method as in any of examples 1-27.

Example 29 is an apparatus for wireless communication including means for implementing a method as in any of examples 1-27.

Example 30 is a non-transitory computer-readable medium storing computer executable code, the code when executed by a processor causes the processor to implement a method as in any of examples 1-27.

1. A method of wireless communication at a user equipment (UE), comprising:
receiving, from a network entity, a configuration for a first transmission configuration indicator (TCI) state list for a first serving cell,
receiving, from the network entity, a first parameter and a second parameter that define a second TCI state list for a second serving cell, the first parameter indicating a type of the second TCI state list for the second serving cell, the second parameter indicating
one or more TCI state identifiers (IDs) in the first TCI state list; and
communicating with the network entity using the second TCI state list for the second serving cell, the second TCI state list being based on the second parameter and the first TCI state list for the first serving cell.

2. The method of claim 1, wherein the configuration for the first TCI state list is further for a third serving cell.

3. The method of claim 1, wherein the second TCI state list for the second serving cell is further based on the first TCI state list for a third serving cell.

4. The method of claim 2, wherein the second parameter indicates the serving cell index and the serving cell index further indicates the third serving cell.

5. The method of claim 2, wherein the second TCI state list for the second serving cell is further based on a combination of the first TCI state list for the first serving cell and the third serving cell.

6. The method of claim 1, wherein the second TCI state list for the second serving cell corresponds to a subset of the first TCI state list for the first serving cell.

7. The method of claim 1, wherein the first TCI state list for the second serving cell corresponds to a first transmission reception point (TRP) and a second TRP, wherein the first serving cell includes a combined TCI state list that correspond to the first TRP and the second TRP.

8. The method of claim 1, wherein the combined TCI state list correspond to at least one of a joint TCI state list, a downlink TCI state list, or an uplink TCI state list.

9. The method of claim 7, wherein the second parameter indicates the one or more TCI state IDs and the first TCI state list for the first serving cell includes one or more third TCI state lists for the first TRP that are separate from one or more fourth TCI state lists for a second TRP.

10. The method of claim 9, wherein a TCI state ID of the one or more TCI state IDs corresponds to the one or more third TCI state lists for the first TRP or the one or more fourth TCI state lists for the second TRP.

11. The method of claim 10, wherein the TCI state ID corresponds to the one or more third TCI state lists for the first TRP, and wherein the second TCI state list for the second serving cell is based on at least one of the one or more third TCI state lists for the first TRP or the second parameter.

12. The method of claim 1, further comprising receiving, from the network entity, at least one of a medium access control-control element (MAC-CE) or downlink control information (DCI) that indicates one or more TCI states from the second TCI state list.

13. The method of claim 1, wherein the first TCI state list and the second TCI state list correspond to any of:
(a) a joint type of TCI state lists for multiple transmission reception points (mTRPs), or
(b) a separate type of TCI state lists for the mTRPs.

14. A method of wireless communication at a network entity, comprising:
transmitting, to a user equipment (UE), a configuration for a first transmission configuration indicator (TCI) state list for a first serving cell;
transmitting, to the UE, a first parameter and a second parameter that define a second TCI state list for a second serving cell, the first parameter indicating a type of the second TCI state list for the second serving cell, the second parameter indicating
one or more TCI state identifiers (IDs) in the first TCI state list; and
communicating with the UE using the second TCI state list for the second serving cell, the second TCI state list being based on the second parameter and the first TCI state list for the first serving cell.

15. The method of claim 14, wherein the configuration for the first TCI state list is further for a third serving cell.

16. The method of claim 14, wherein the second TCI state list for the second serving cell is further based on the first TCI state list for a third serving cell.

17. The method of claim 14, wherein the first TCI state list and the second TCI state list correspond to any of:
(a) a joint type of TCI state lists for multiple transmission reception points (mTRPs), or
(b) a separate type of TCI state lists for the mTRPs.

18. An apparatus for wireless communication at a user equipment (UE), comprising:
a transceiver;
a memory; and
a processor coupled to the memory and the transceiver, the processor configured to:
receive, from a network entity, a configuration for a first transmission configuration indicator (TCI) state list for a first serving cell;
receive, from the network entity, a first parameter and a second parameter that define a second TCI state list for a second serving cell, the first parameter indicating a type of the second TCI state list for the second serving cell, the second parameter indicating one or more TCI state identifiers (IDs) in the first TCI state list; and
communicate with the network entity using the second TCI state list for the second serving cell, the second TCI state list being based on the second parameter and the first TCI state list for the first serving cell.

19. The apparatus of claim 18, wherein the configuration for the first TCI state list is further for a third serving cell.

20. The apparatus of claim 18, wherein the first TCI state list and the second TCI state list correspond to any of:
(a) a joint type of TCI state lists for multiple transmission reception points (mTRPs), or
(b) a separate type of TCI state lists for the mTRPs.
